(19) United States
(12) Patent Application Publication
(10) Pub. No.: US 2020/0159535 A1
(43) Pub. Date: May 21, 2020

(54) REGISTER DEALLOCATION IN A PROCESSING SYSTEM

(71) Applicant: International Business Machines Corporation, Armonk, NY (US)

(72) Inventors: James Bonanno, Wappingers Falls, NY (US); Gregory William Alexander, Pflugerville, TX (US); Avery Francois, Austin, TX (US); Richard Joseph Branciforte, Austin, TX (US)

(21) Appl. No.: 16/194,456

(22) Filed: Nov. 19, 2018

(51) Int. Cl. G06F 9/38; G06F 9/30

(52) U.S. Cl. CPC G06F 9/384; G06F 9/30105

(57) ABSTRACT

Aspects include storing a plurality of mappings of logical registers to physical registers in a first structure of a processor. An updated mapping of one or more of the logical registers to the physical registers based on a group of instructions is received. A plurality of allocated register mapping entries associated with the updated mapping of the first structure is split into a first register allocation group and a second register allocation group. A second structure of the processor is updated with the updated mapping of the first register allocation group. A third structure of the processor is updated with the updated mapping of the second register allocation group.

### BACKGROUND

The present invention relates to computer systems, and more particularly, to register deallocation in a processing system.

High performance microprocessor designs use mapping functions to allocate and deallocate shared resources, such as physical registers. Mapping support structures, such as a history buffer mapper, can contain information about the allocation of logical registers to physical registers, for instance, to support multiple threads and/or speculative execution of instructions. Processors can use other tracking mechanisms, such as a global completion table, to track the progress of groups of instructions through a processing pipeline from dispatch through completion.

### SUMMARY

According to one or more embodiments of the present invention, a computer-implemented method includes storing a plurality of mappings of logical registers to physical registers in a first structure of a processor. An updated mapping of one or more of the logical registers to the physical registers based on a group of instructions is received. A plurality of allocated register mapping entries associated with the updated mapping of the first structure is split into a first register allocation group and a second register allocation group. A second structure of the processor is updated with the updated mapping of the first register allocation group. A third structure of the processor is updated with the updated mapping of the second register allocation group.

Other embodiments of the invention implement the features of the above-described method in a computer system and in a computer program product.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram illustrating a computer system in accordance with various embodiments of the invention;

FIG. 2 is a block diagram of a portion of a processor according to a non-limiting embodiment;

FIG. 3 is a block diagram of physical registers to be allocated and deallocated according to a non-limiting embodiment;

FIG. 4 is a block diagram of a working set mapper to support physical register allocation and deallocation according to a non-limiting embodiment;

FIG. 5 is a block diagram of a history buffer mapper according to a non-limiting embodiment;

FIG. 6 is a block diagram of history buffer mapper restoration of a working set mapper according to a non-limiting embodiment;

FIG. 7 is a block diagram of a mapper optimization according to a non-limiting embodiment;

FIG. 8 is an instruction sequence diagram illustrating a method according to a non-limiting embodiment; and

FIG. 9 is a flow diagram illustrating a method according to a non-limiting embodiment.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” can include any integer number greater than or equal to one, i.e. one, two, three, four, etc. The terms “a plurality” can include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, instruction processing within a processor can include mapping of logical resources, such as registers, to physical resources in an instruction processing pipeline and deallocating of such resources. In a design with support structures, such as a mapper history buffer (MHB) and group-based instruction tracking through a global completion table (GCT), the MHB and GCT can be used to track register allocation and support deallocation of physical registers. Register deallocation may be supported either by using information tracked in the MHB or the GCT, which can include physical register numbers, for example. Further, in some processing systems, various addressing modes and/or instructions may not use the entire data width of the processor. Consequently, multiple register files (also referred to herein as sub-register files) that are a fraction of the processor width (e.g., 32 bits instead of 64 bits) may be used to enable complete utilization of a register memory array. When accessing larger data types, multiple sub-register files may be accessed in parallel to provide data that spans the complete processor data width. The possibility of using multiple structures and supporting sub-registers for mapping between logical and physical registers can result in a large quantity of tracking data, including potentially capturing redundant or unnecessary information.

Turning now to an overview of the aspects of the invention, one or more embodiments of the invention address the above-described shortcomings of the prior art by splitting register mapping tracking between multiple structures. Physical registers can be deallocated once the physical registers no longer need to be read. Upon completing an instruction writing a particular logical register, the previous physical register to which that logical register was mapped is no longer needed and can be deallocated. Upon flushing an instruction that writes a logical register, the new physical register to which that logical register was mapped by this instruction is no longer needed and can be deallocated. For an instruction writing a logical register, tracking can be performed for both the previous (i.e., evicted) and new physical register mapping of the register being written. In designs with group-based tracking of instructions in a GCT, entire groups of instructions are tracked together and are completed or flushed together as a group. Architected instructions can be expanded into multiple groups of micro operations by the hardware. Some actions can be taken upon group completion of such expanded instructions, while other actions can be taken upon instruction completion of such expanded instructions—specifically once all groups of the instruction have completed. Embodiments can split tracking between an MHB and GCT. Specifically, the MHB may only track one previous mapping for each logical register written by a group rather than tracking all mappings of the group within the MHB. The MHB can also track a subset of new mappings for each logical register written by a group. Within the GCT, tracking of a different subset of the new mappings can be captured. In some embodiments, the MHB can contain required information for doing register deallocation upon completing instructions. The MHB can also be used for deallocating post-group registers upon flush. The GCT can contain the remaining information for performing intermediate register deallocation upon group completion or upon a flush. Embodiments are applicable in systems with or without sub-registers.

The above-described aspects of the invention address the shortcomings of the prior art by avoiding redundancy in storing required information while reducing the number of MHB entries that need to be written upon mapping registers for groups of instructions with multiple writes to the same logical register. Technical effects and benefits can include decreasing the area overhead for tracking and improving the performance of a mapper by reducing the number of entries that need to be allocated in the MHB and/or other tracking structures of a processor.

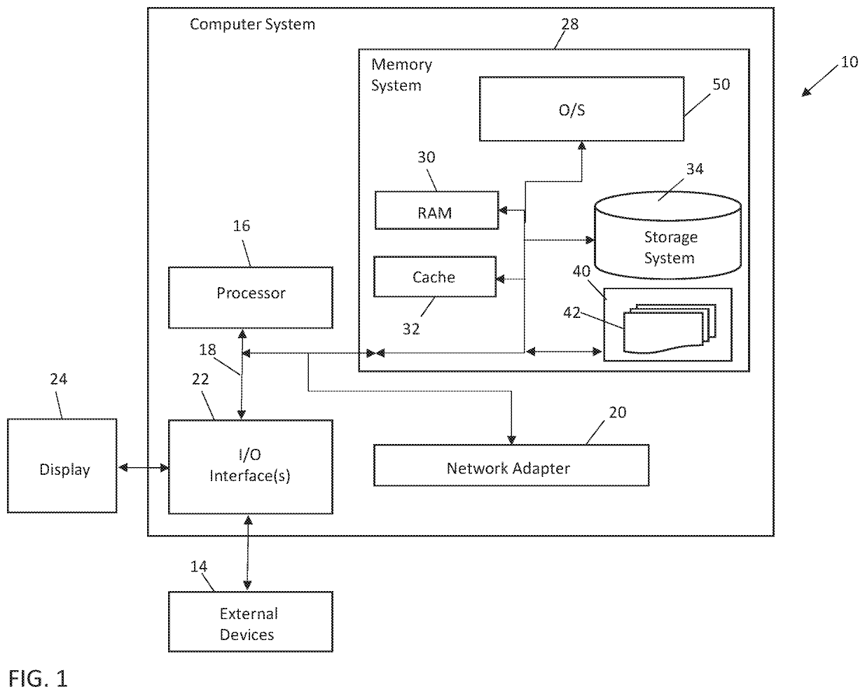

With reference now to FIG. 1, a computer system 10 is illustrated in accordance with a non-limiting embodiment of the present disclosure. The computer system 10 may be based on the z/Architecture, for example, offered by International Business Machines Corporation (IBM). The architecture, however, is only one example of the computer system 10 and is not intended to suggest any limitation as to the scope of use or functionality of embodiments described herein. Regardless, computer system 10 is capable of being implemented and/or performing any of the functionality set forth hereinabove.

Computer system 10 is operational with numerous other computing system environments or configurations. Examples of well-known computing systems, environments, and/or configurations that may be suitable for use with computer system 10 include, but are not limited to, personal computer systems, server computer systems, thin clients, thick clients, cellular telephones, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Further, elements of the computer system 10 can be incorporated in one or more network devices to support computer network functionality, such as a network switch, a network router, or other such network support devices.

Computer system 10 may be described in the general context of computer system-executable instructions, such as program modules, being executed by the computer system 10. Generally, program modules may include routines, programs, objects, components, logic, data structures, and so on that perform particular tasks or implement particular abstract data types. Computer system 10 may be practiced in distributed cloud computing environments where tasks are performed by remote processing devices that are linked through a communications network. In a distributed computing environment, program modules may be located in both local and remote computer system storage media including memory storage devices.

As shown in FIG. 1, computer system 10 is shown in the form of a computing device, also referred to as a processing device. The components of computer system may include, but are not limited to, a processor 16 including one or more processing cores or processing units, a memory system 28, and a bus 18 that operably couples various system components including memory system 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 10 may include a variety of computer system readable media. Such media may be any available media that are accessible by computer system/server 10, and they include both volatile and non-volatile media, removable and non-removable media.

Memory system 28 can include an operating system (OS) 50, along with computer system readable media in the form of volatile memory, such as random access memory (RAM) 30 and/or cache memory 32. Computer system 10 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory system 28 may include at least one program product having a set (e.g., at least one) of program modules that are configured to carry out the functions of embodiments of the disclosure.

The OS 50 controls the execution of other computer programs and provides scheduling, input-output control, file and data management, memory management, and communication control and related services. The OS 50 can also include communication protocol support as one or more drivers to implement various protocol layers in a protocol stack (e.g., transmission control protocol/internet protocol (TCP/IP)) to support communication with other computer systems across one or more computer networks.

The storage system 34 can store a basic input output system (BIOS). The BIOS is a set of essential routines that initialize and test hardware at startup, start execution of the OS 50, and support the transfer of data among the hardware devices. When the computer system 10 is in operation, the processor 16 is configured to execute instructions stored within the storage system 34, to communicate data to and from the memory system 28, and to generally control operations of the computer system 10 pursuant to the instructions.

Program/utility 40, having a set (at least one) of program modules 42, may be stored in memory system 28 by way of example, and not limitation, as well as the OS 50, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein at an application layer level in a communication protocol stack.

Computer system 10 may also communicate with one or more external devices 14 such as a keyboard, a pointing device, a display 24, etc.; one or more devices that enable a user to interact with computer system/server 10; and/or any devices (e.g., network card, modem, etc.) that enable computer system/server 10 to communicate with one or more other computing devices. Such communication can occur via Input/Output (I/O) interfaces 22. Still yet, computer system 10 can communicate with one or more networks such as a local area network (LAN), a general wide area network (WAN), and/or a public network (e.g., the Internet) via network adapter 20. As depicted, network adapter 20 communicates with the other components of computer system 10 via bus 18. It should be understood that although not shown, other hardware and/or software components could be used in conjunction with computer system 10. Examples include, but are not limited to: microcode, device drivers, redundant processing units, external disk drive arrays, RAID systems, tape drives, data archival storage systems, etc.

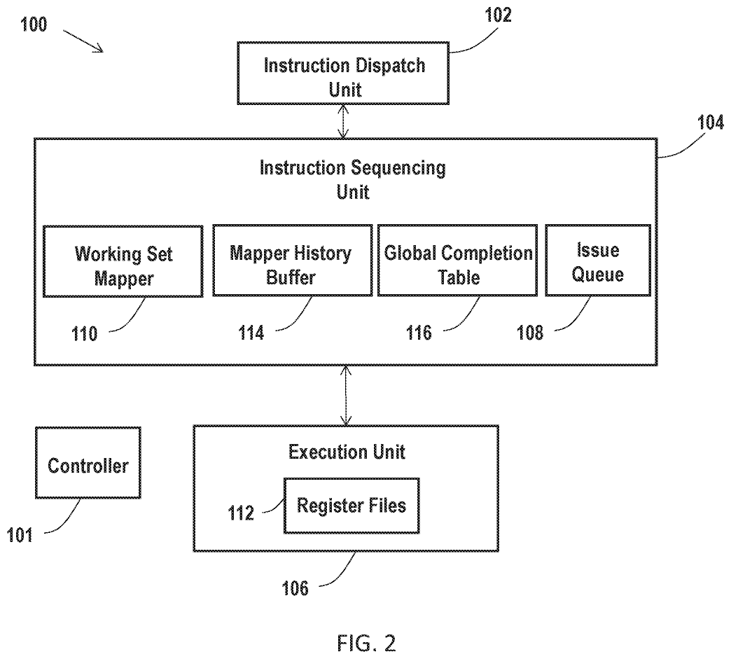

Turning now to a more detailed description of aspects of the present invention, FIG. 2 depicts a block diagram of a system 100 that can be part of the processor 16 of FIG. 1. The system 100 can include a plurality of functional units of a processing pipeline, such as an instruction dispatch unit 102, an instruction sequencing unit 104, and an execution unit 106. Although only three units 102-106 are depicted in FIG. 2, it will be understood that the system 100 can include additional functional units known in the art that are not depicted in FIG. 2. Further, there can be multiple units and/or sub-units, such as multiple execution units 106, although a single instance of the execution unit 106 is depicted in FIG. 2. For example, the execution unit 106 may include one or more fixed-point execution units, floating-point execution units, load/store execution units, and/or vector execution units. The instruction dispatch unit 102, instruction sequencing unit 104, and execution unit 106 can each have one or more pipelines with multiple stages. After instruction dispatching by the instruction dispatch unit 102, the instruction sequencing unit 104 can route and sequence instructions through an issue queue 108 to the execution unit 106 for execution.

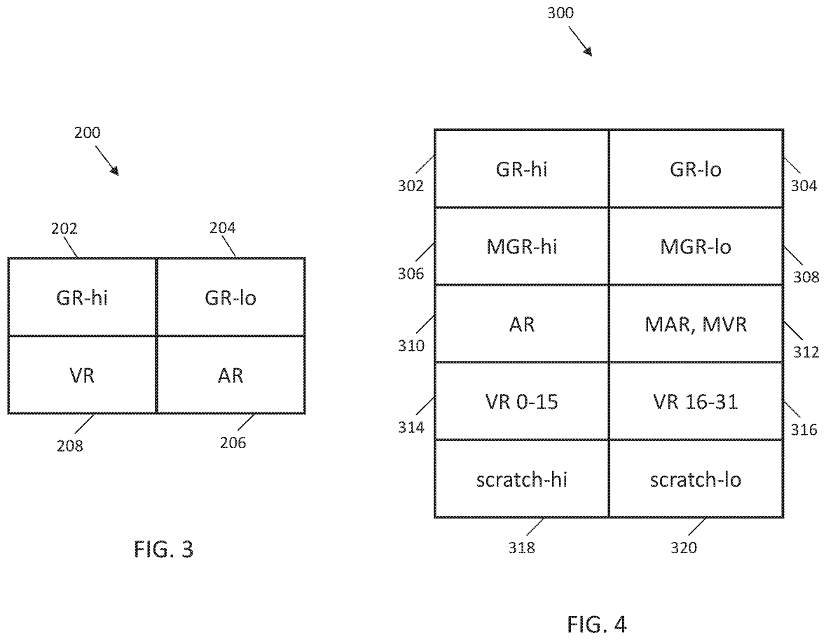

To support allocation and tracking of resources, such as allocation and deallocation of logical to physical resources, the instruction sequencing unit 104 can access a working set mapper (MWS) 110 that tracks a current state of mapping logical registers to physical registers that can be accessible to the execution unit 106 as register files 112. A MHB 114 can track mapping history to enable restoration of the MWS 110 on a flush. A GCT 116 can assist in completion tracking of groups of instructions and assist in the tracking of register allocation history information. A controller 101 can be implemented in low-level code and/or hardware to control the movement of instructions, data, and tracking information through the system 100. Further details are provided with respect to FIGS. 3-9.

FIG. 3 depicts an example of physical registers 200 that can be part of the register files 112 of FIG. 2. In this example, there are four physical register pools, including two for General Purpose Registers (GRs), which can have separate pools for sub-register mappings of the GRs—a high half (“GR-hi” 202) and a low half (“GR-lo” 204). As an example, GRs can be 64-bits, with the high half 202 including bits 0:31 and the low half 204 including bits 32:63. Other types of registers in this example are access registers “AR” 206 and vector registers “VR” 208.

An MWS 300 is depicted in FIG. 4 as an example of MWS 110 of FIG. 2 to store current mappings of logical registers to physical registers 200. The MWS 300 can be indexed, for instance, by a logical register type and number. In a design with multithreading support, the MWS would have mappings for each thread either by using the thread as part of the index into the structure, or by having a separate copy of the MWS for each thread. FIG. 4 shows an example of MWS 300 structured as pools of mappings for each logical register type. The register types include general purpose registers (GRs) with GR-hi 302 and GR-lo 304, millicode general registers (MGRs) with MGR-hi 306 and MGR-lo 308, access registers (ARs) 310, millicode access registers (MARs) with millicode vector registers (MVRs) 312, vector registers (VRs 0-15) 314 and (VRs 16-31) 316, and scratch registers with scratch-hi 318 and scratch-lo 320 which can be used when cracking architected instructions into microinstructions.

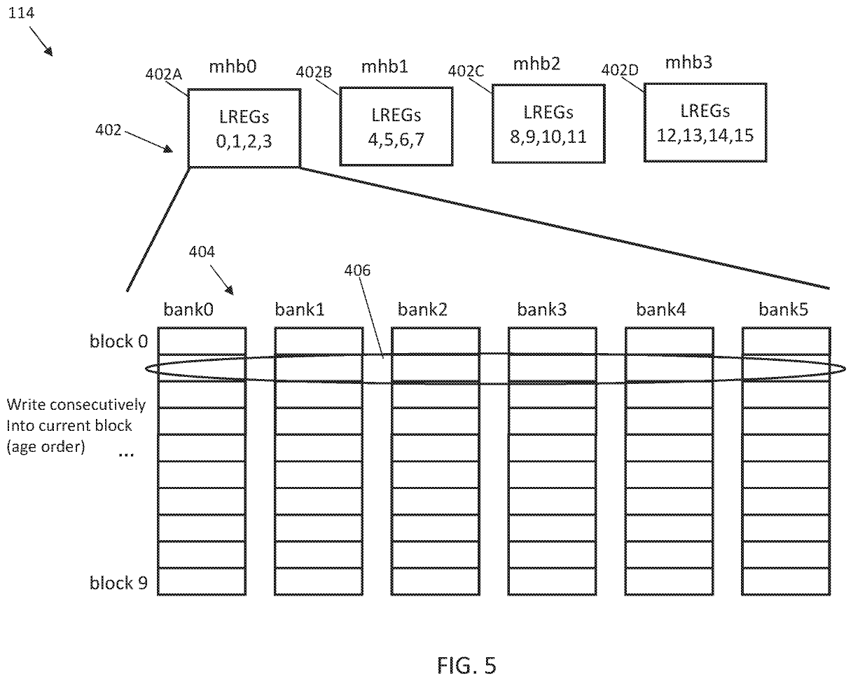

FIG. 5 shows an example of how the MHB 114 can be structured. The MHB 114 may be logically an in-order list of evicted mappings from the MWS 110 of FIG. 2. The MHB 114 can be structured in various ways, such as being partitioned by logical register number. Entries 402 can be structured in blocks 404 for allocation/deallocation which allows efficient management for age ordering, thread sharing, and a register file implementation.

The example of FIG. 5 includes 16 logical registers of each type (LREGs 0-15). A logical register number can be 4-bits, where the most significant 2-bits can determine which MHB 114 section to use and the least significant 2-bits can be stored within the entries 402. In addition to the LREG type and number, entries 402 of the MHB 114 can also include an evicted mapping (e.g., a physical register number) and evictor identifier. Entries 402 within each block 404 can be maintained in age order. An age array (not depicted) can track the relative age of the blocks 404. In a multithreaded design, any particular block 404 may be assigned to any thread. All entries in a block 404 can be for the same thread. In this example, there are six entries 402 in each block 404. This arrangement may work particularly well if there are six or fewer writes that are required each cycle, where each bank may only need one write port. In the example of FIG. 5, a multi-bank access 406 can span across bank0, bank1, bank2, bank3, bank4, and bank5. The entries 402 may also be grouped with LREGS 0, 1, 2, 3 in mhb0 402A; LREGS 4, 5, 6, 7 in mhb1 402B; LREGS 8, 9, 10, 11 in mhb2 402C; and, LREGS 12, 13, 14, 15 in mhb3 402D.

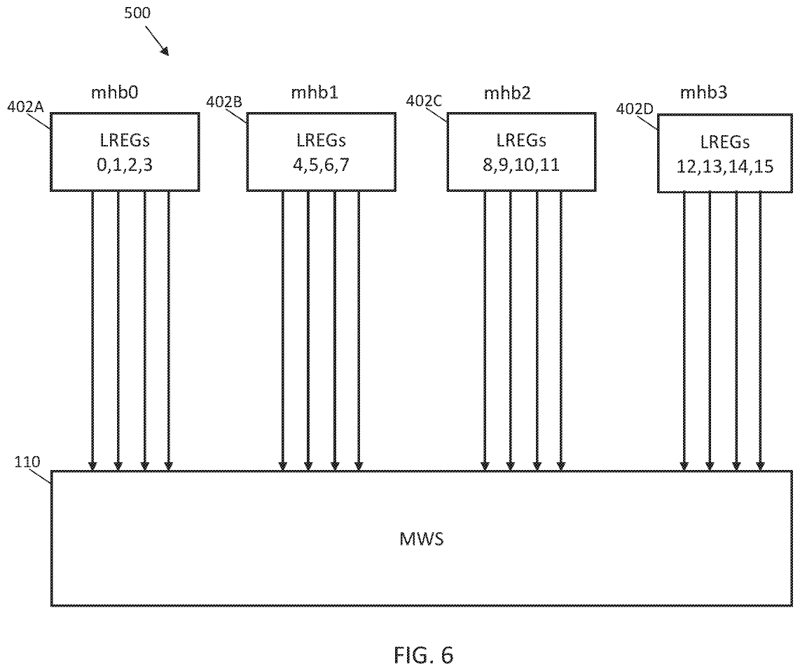

FIG. 6 shows an example of how the MHB 114 to MWS 110 restore process 500 can be structured for mhb0 402A-mhb3 402D. Physical registers 200 can be deallocated once the physical registers 200 no longer need to be read. Upon completing an instruction that writes a logical register, the physical register that was the prior mapping of that register can be deallocated. Upon flushing an instruction that writes a logical register, the corresponding physical register can be deallocated.

New mappings are allocated within a pipeline of processor 16. This can occur in a decode time frame, or alternatively at other time frames, such as at issue time when instructions are sent to the execution unit 106, potentially out of order. Regardless of the exact time frame, mappings for register sources can be read from a mapper, and new mappings for target registers can be written into the MWS 110. At this time, prior mappings of the target registers can also be read from MWS 110 and written into the MHB 114. Embodiments can affect how many entries are written into the MHB 114 as well as what type of information is written into the MHB 114 and the GCT 116 of FIG. 2 to enable physical register deallocation.

Embodiments can store information in MHB 114 and GCT 116 for register deallocation. Specifically, the MHB 114 may already have evicted mappings (old/prior mappings before an instruction that remapped a logical register) for restoring the MWS 110 upon a flush. The evicted mappings can be used for deallocation upon instruction completion. Thus, upon instruction completion, the controller 101 or other logic can look for an instruction identifier in the MHB 114 and mark the affected entry for register deallocation. Then in future cycles, the MHB 114 can be searched for entries 402 that need deallocation and the information can be read from the selected entries 402 to perform the deallocation. The data can be located within an SRAM array or register file, while the controls can be in latches of the controller 101 or other components. Information in the MHB 114 and GCT 116 used for register deallocation can include the thread, physical register type, and physical register number.

Embodiments can distribute newly allocated register mappings between MHB 114 and GCT 116. One option can include storing all newly allocated register mappings in GCT 116 and none in MHB 114. Alternatively, some register allocations can be stored in MHB 114, such as the one youngest, and intermediate register allocations can be stored in the GCT 116. Upon flush events, the controller 101 can determine which instruction identifiers are being flushed and mark the instructions as needing register deallocations in both the GCT 116 and MHB 114. The controller 101 can search for entries requiring deallocation, read associated information, and perform the deallocation. Upon group completion, any of the intermediate mappings that do not survive the group can be deallocated from the GCT 116.

As an example, consider a case where mapping happens at around a decode stage in the processor 16, where instructions being decoded in order are mapped simultaneously. At that time, entries can be written into the MHB 114 with the evicted mappings. If there are multiple writers within a group to the same logical register, only one entry 402 of the MHB 114 may be written. The entry 402 can contain physical register mappings prior to a group of instructions. The entry 402 can also contain a subset of the new mappings, specifically mappings not tracked in the GCT 116. The controller 101 can also be aware of sub-register validity and can decide what to write on a sub-register basis.

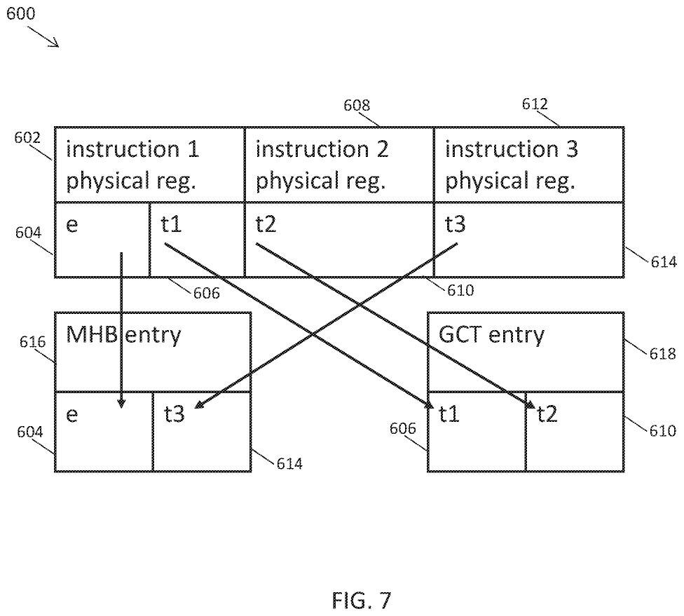

FIG. 7 depicts an example of a group of instructions 600 with a mapper optimization according to an embodiment. The group of instructions 600 includes a sequence of mappings where a same logical reference is reallocated to multiple physical registers, for instance, due to consecutive instructions which all write their results into the same logical register. A first instruction physical register 602 mapping changes from an evicted mapping (e) 604 to a first updated register mapping (t1) 606. A second instruction physical register 608 mapping references a second updated register mapping (t2) 610. A third instruction physical register 612 mapping references a third updated register mapping (t3) 614. Under a less efficient approach, the group of instructions 600 could result in three entries 402 into the MHB 114 to track a first pairing of the evicted mapping (e) 604 to the first updated register mapping (t1) 606, a second pairing of the first updated register mapping (t1) 606 to the second updated register mapping (t2) 610, and a third pairing of the second updated register mapping (t2) 610 to the third updated register mapping (t3) 614. Embodiments can improve efficiency by performing the tracking as creating an MHB entry 616 that includes a pairing of the evicted mapping (e) 604 to the third updated register mapping (t3) 614 (which is the final mapping of the group of instructions 600) and creating a GCT entry 618 that includes a pairing of the first updated register mapping (t1) 606 and the second updated register mapping (t2) 610.

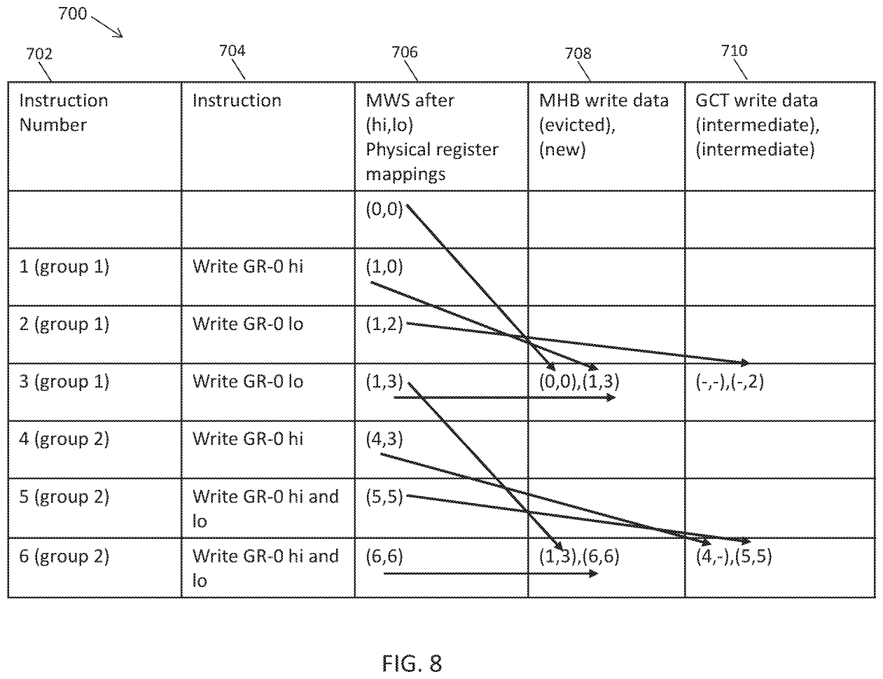

FIG. 8 shows an example instruction sequence 700 in the context of three-instruction groups. In FIG. 8, there are six consecutive instructions in two groups: group 1 and group 2, as depicted in instruction numbers 702 for instructions 704 with MWS mappings 706, MHB mappings 708, and GCT mappings 710. Prior to group 1, the MWS mapping 706 for logical register GR-0 is to hi physical GR number 0 and lo physical GR number 0, represented as (hi, lo)=(0,0).

After decoding group 1, a single MHB entry of MHB mappings 708 can be written corresponding to all the writes to logical register GR-0. The entry can include evicted pre-group mappings of (0,0), and post-group new mappings of (1,3). The GCT 116 can contain room for two intermediate mappings for this group. The first of the GCT mappings 710 may be invalid since the first instruction in the group only writes GR-0 hi and that write survives the group and is tracked in the MHB 114. A second intermediate mapping can have a valid lo physical register and is indicated in FIG. 8 as (−,2) in the GCT mappings 710, which indicates that the hi half is invalid, and the lo half is valid and is lo physical register 2. Upon completing all the instructions in group 1, the MHB 114 can deallocate physical registers (0,0) and GCT 116 can deallocate the physical register (−,2). If instead group 1 gets flushed, MHB 114 may instead deallocate physical registers (1,3) and the GCT 116 can still deallocate physical register (−,2).

After decoding group 2, another single MHB entry can be written corresponding to all the writes in that group to logical register GR-0. The entry in the MHB mapping 708 can include evicted pre-group mappings of (1,3), and the post-group new mappings of (6,6). The GCT entry for GCT mapping 710 of the group may be written with two valid intermediate mappings (4,−) and (5,5). Upon completing all instructions in group 2, MHB 114 can deallocate physical registers (1,3), and the GCT 116 may deallocate physical registers (4,−) and (5,5). If instead group 1 gets flushed, MHB 114 can instead deallocate physical registers (6,6), and GCT 116 can still deallocate physical registers (4,−) and (5,5).

Some designs may contain scratch registers that are written by micro-instructions generated in decode logic by expanding architected instructions into a sequence of simpler micro-instructions. In such designs, micro-instructions can write and read a micro-architected set of logical registers called scratch registers. Scratch registers may not survive a group. So, upon instruction completion of such a group, the new/written scratch physical registers can be deallocated, rather than an evicted scratch register allocation. Embodiments may be further optimized to avoid writing scratch register mappings in the MHB 114 since the mappings are not needed for MWS 110 flush restoration but only for physical register deallocation as long as there is room to write in the GCT 116.

Embodiments can be implemented in a way that makes the GCT 116 capabilities of physical register deallocation optional. For instance, hardware may be statically or dynamically configured to rely on solely the MHB 114 for register tag deallocation. When configured this way, the write-after-write optimization and any scratch register optimizations can be disabled. Therefore, every instruction writing a logical register can write an entry to the MHB 114 containing both the evicted mappings and the new mappings.

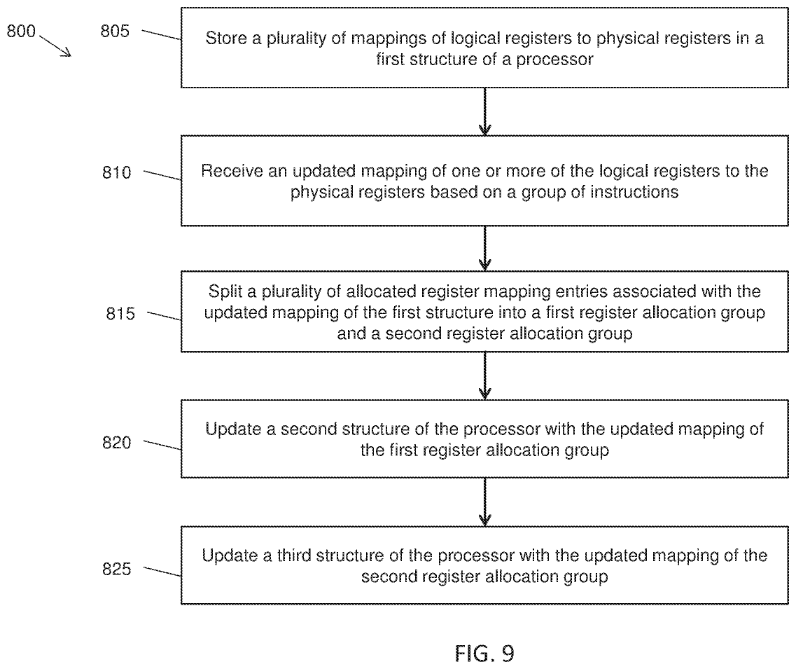

Turning now to FIG. 9, a flow diagram of a process 800 is generally shown in accordance with an embodiment. The process 800 is described with reference to FIGS. 1-8 and may include additional steps beyond those depicted in FIG. 9. The process 800 can be performed by the processor 16 of FIG. 1.

At block 805, a plurality of mappings of logical registers to physical registers is stored in a first structure of the processor 16, such as the MWS 110. At block 810, an updated mapping of one or more of the logical registers to the physical registers can be received based on a group of instructions. At block 815, a plurality of allocated register mapping entries associated with the updated mapping of the first structure can be split into a first register allocation group and a second register allocation group. At block 820, a second structure of the processor 16 is updated with the updated mapping of the first register allocation group, such as the MHB 114. At block 825, a third structure of the processor 16 can be updated with the updated mapping of the second register allocation group, such as the GCT 116.

In some embodiments, the first register allocation group includes an evicted mapping of the MWS 110 and a final mapping of the group of instructions. The second register allocation group can include one or more intermediate mappings that occur in a sequence between the evicted mapping and the final mapping. The evicted mapping can be deallocated from the MHB 114 and the one or more intermediate mappings from the GCT 116 based on completion of the group of instructions. The final mapping can be deallocated from the MHB 114 and the one or more intermediate mappings from the GCT 116 based on a flush of the group of instructions, and the MWS 110 can be restored with the evicted mapping from the MHB 114 based on the flush of the group of instructions. The first register allocation group and the second register allocation group can include one or more sub-register mappings for separate portions of the same logical register. One or more scratch register mappings can be tracked in the second register allocation group and omitted from the first register allocation group. The first register allocation group can include an evicted mapping of the first structure and the second register allocation group comprises one or more new mappings of the first structure based on the group of instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
storing a plurality of mappings of logical registers to physical registers in a first structure of a processor;
receiving an updated mapping of one or more of the logical registers to the physical registers based on a group of instructions;
splitting a plurality of allocated register mapping entries associated with the updated mapping of the first structure into a first register allocation group and a second register allocation group;
updating a second structure of the processor with the updated mapping of the first register allocation group; and
updating a third structure of the processor with the updated mapping of the second register allocation group.

2. The computer-implemented method of claim 1, wherein the first structure comprises a working set mapper, the second structure comprises a mapper history buffer, and the third structure comprises a global completion table.

3. The computer-implemented method of claim 2, wherein the first register allocation group comprises an evicted mapping of the working set mapper and a final mapping of the group of instructions.

4. The computer-implemented method of claim 3, wherein the second register allocation group comprises one or more intermediate mappings that occur in a sequence between the evicted mapping and the final mapping.

5. The computer-implemented method of claim 4, further comprising:
deallocating the evicted mapping from the mapper history buffer and the one or more intermediate mappings from the global completion table based on completion of the group of instructions.

6. The computer-implemented method of claim 4, further comprising:
deallocating the final mapping from the mapper history buffer and the one or more intermediate mappings from the global completion table based on a flush of the group of instructions; and
restoring the working set mapper with the evicted mapping from the mapper history buffer based on the flush of the group of instructions.

7. The computer-implemented method of claim 1, wherein the first register allocation group and the second register allocation group comprise one or more sub-register mappings for separate portions of a same logical register, and/or one or more scratch register mappings are tracked in the second register allocation group and omitted from the first register allocation group.

8. The computer-implemented method of claim 1, wherein the first register allocation group comprises an evicted mapping of the first structure and the second register allocation group comprises one or more new mappings of the first structure based on the group of instructions.

9. A system of a processor, the system comprising:
a plurality of physical registers; and
a controller configured to perform a plurality of operations comprising:
storing a plurality of mappings of logical registers to the physical registers in a first structure of the processor;
receiving an updated mapping of one or more of the logical registers to the physical registers based on a group of instructions;
splitting a plurality of allocated register mapping entries associated with the updated mapping of the first structure into a first register allocation group and a second register allocation group;
updating a second structure of the processor with the updated mapping of the first register allocation group; and
updating a third structure of the processor with the updated mapping of the second register allocation group.

10. The system of claim 9, wherein the first structure comprises a working set mapper, the second structure comprises a mapper history buffer, and the third structure comprises a global completion table.

11. The system of claim 10, wherein the first register allocation group comprises an evicted mapping of the working set mapper and a final mapping of the group of instructions.

12. The system of claim 11, wherein the second register allocation group comprises one or more intermediate mappings that occur in a sequence between the evicted mapping and the final mapping.

13. The system of claim 12, wherein the controller is further configured to perform operations comprising:
deallocating the evicted mapping from the mapper history buffer and the one or more intermediate mappings from the global completion table based on completion of the group of instructions.

14. The system of claim 12, wherein the controller is further configured to perform operations comprising:
deallocating the final mapping from the mapper history buffer and the one or more intermediate mappings from the global completion table based on a flush of the group of instructions; and
restoring the working set mapper with the evicted mapping from the mapper history buffer based on the flush of the group of instructions.

15. The system of claim 9, wherein the first register allocation group and the second register allocation group comprise one or more sub-register mappings for separate portions of a same logical register, and/or one or more scratch register mappings are tracked in the second register allocation group and omitted from the first register allocation group.

16. The system of claim 9, wherein the first register allocation group comprises an evicted mapping of the first structure and the second register allocation group comprises one or more new mappings of the first structure based on the group of instructions.

17. A computer program product comprising a computer readable storage medium having program instructions embodied therewith, the program instructions executable by a processor to perform a plurality of operations comprising:
storing a plurality of mappings of logical registers to physical registers in a first structure of a processor;
receiving an updated mapping of one or more of the logical registers to the physical registers based on a group of instructions;
splitting a plurality of allocated register mapping entries associated with the updated mapping of the first structure into a first register allocation group and a second register allocation group;
updating a second structure of the processor with the updated mapping of the first register allocation group; and
updating a third structure of the processor with the updated mapping of the second register allocation group.

18. The computer program product of claim 17, wherein the first structure comprises a working set mapper, the second structure comprises a mapper history buffer, and the third structure comprises a global completion table.

19. The computer program product of claim 18, wherein the first register allocation group comprises an evicted mapping of the working set mapper and a final mapping of the group of instructions, and the second register allocation group comprises one or more intermediate mappings that occur in a sequence between the evicted mapping and the final mapping.

20. The computer program product of claim 19, wherein the processor is further configured to perform operations comprising:
deallocating the evicted mapping from the mapper history buffer and the one or more intermediate mappings from the global completion table based on completion of the group of instructions;
deallocating the final mapping from the mapper history buffer and the one or more intermediate mappings from the global completion table based on a flush of the group of instructions; and
restoring the working set mapper with the evicted mapping from the mapper history buffer based on the flush of the group of instructions.
